(19) United States
(12) Patent Application Publication
(10) Pub. No.: US 2019/0247967 A1
(43) Pub. Date: Aug. 15, 2019

(54) GRAVITY ASSIST SYSTEM

(71) Applicant: KAL TIRE, Vernon (CA)

(72) Inventors: Clayton Wilford Russell MCMUNN, Lake Country, BC (CA); Jan Peter NILSSON, Kelowna, BC (CA)

(21) Appl. No.: 16/331,816

(22) PCT Filed: Sep. 8, 2017
(86) PCT No.: PCT/CA2017/051064

§ 371 Date: Mar. 8, 2019

(30) Foreign Application Priority Data
Sep. 9, 2016 (CA) 2,941,624

(51) Int. Cl. B23Q 1/28; B23Q 1/26; B25J 1/12

(52) U.S. Cl. CPC B23Q 1/28; B25J 1/12; B23Q 1/262

(57) ABSTRACT

According to at least one embodiment, a gravity assist system comprises a plurality links and a means for holding at least one tool, wherein the plurality links are configured to permit a user to reposition the at least one tool within a work envelope.

### FIELD

This disclosure relates generally to a gravity assist system or apparatus for assisting a tool or device to maneuver within a work area or envelope.

### BACKGROUND

Large tools can be a challenge to manipulate and control for human operators. There is accordingly a need for a system or apparatus that can assist in maneuvering and positioning such tools within a work area or envelope.

### SUMMARY

A gravity assist system may be used to support the weight of ‘heavy’ tools, such as power tools for example, that may otherwise be supported by direct human force. In at least one embodiment, a G.A.S. is designed to allow a tool to be maneuvered and positioned within a defined work envelope or work area using potentially less human effort than would be required without the G.A.S., and the human effort may be supplemented by mechanical assistance. For example, some embodiments may include a G.A.S. base and a series of manipulative links between the tool and the G.A.S. base. In at least some embodiments, the G.A.S. base can be equipped with wheels or stationary feet, can be fitted to a track, or can be mounted to a vehicle in order to achieve mobility, for example. During operation of at least some embodiments, the tool can be maneuvered manually throughout the work envelope and may not require further mechanical adjustments or control input to the machine. The G.A.S. of at least some embodiments may also equipped with positional locks to fix the tool in a desired location, orientation, or range of motion within the work envelope. In at least some embodiments, the links may be manipulated by a combination of direct human force and powered actuation. Actuation may, in at least some embodiments, be controlled by human input to a Human/Machine Interface (H.M.I.).

In accordance with one aspect, there is provided an apparatus for assisting in maneuvering and positioning a tool within a work envelope, the apparatus comprising: a tool clamp configured to releasably connect to the tool; a tool arm operably connected to the tool clamp; a pitch knuckle operably connected to the tool arm, the pitch knuckle comprising an axis pivot, a floating segment and a fixed segment, wherein the axis pivot connects the floating segment and the fixed segment and allows the floating segment and the fixed segment to rotate relative to each other; a swing pivot; a lift arm connected to the pitch knuckle via the swing pivot, the swing pivot configured to allow the pitch knuckle to swing along a plane relative to the lift arm; a base including a mast; and a slider operably connected to the lift arm and the mast, wherein the slider is operably configured to move generally towards and away from a front portion of the base.

In some embodiments, the pitch knuckle includes an adjustable mechanical assist device mounted offset to the axis pivot to counteract force applied by the tool arm on the floating segment to allow the tool arm to balance and pitch freely relative to the fixed segment. In some embodiments, the floating segment is connected to the tool arm via a swivel bearing. In some embodiments, the apparatus further comprises a swivel bearing connected to the tool arm, the swivel bearing having an axis of rotation aligned with an axis of the tool clamp. In some embodiments, the swing pivot includes a swing lock to fix a swing angle of the pitch knuckle relative to the lift arm to prevent the tool from swinging freely. In some embodiments, the lift arm includes a floating end and a fixed end connected to the floating end to allowing generally vertical constrained movement between said ends. In some embodiments, the slider is operably configured to rotate around a longitudinal axis of the mast. In some embodiments, the mast includes an upper segment and a lower segment, connected by a series of sliders and rollers allowing segments to move linearly relative to each other while restricting relative horizontal or rotational movement; In other embodiments, the base is removable from the rest of the apparatus, allowing the apparatus to be mounted onto mobile equipment or other fixed platforms. In other embodiments, a utility box is attached to the base providing storage, wherein a top surface of the utility box is configured to allow for use as a workbench.

Other aspects and features will become apparent to those ordinarily skilled in the art upon review of the following description of illustrative embodiments in conjunction with the accompanying figures.

### BRIEF DESCRIPTION OF THE DRAWINGS

FIG. 1 is a perspective view of a G.A.S. according to one embodiment.

FIG. 2 is an elevation view of a ‘strong arm’ or ‘strong arm assembly’ of the G.A.S. of the embodiment of FIG. 1.

FIG. 3 is a perspective view of the G.A.S. of the embodiment of FIG. 1, illustrating approximate dimensions of the G.A.S. of the embodiment of FIG. 1. Dimensions may vary in other embodiments.

FIG. 4 is a top view of an example of operation of the G.A.S. of the embodiment of FIG. 1 during outer (top of FIG. 4) and inner (bottom of FIG. 4) wheel removal.

FIG. 5 is a perspective view of a G.A.S. according to another embodiment.

FIG. 6 is a partial elevation view of the G.A.S. of the embodiment of FIG. 5.

FIG. 7 is a perspective view of the G.A.S. of the embodiment of FIG. 5, illustrating approximate dimensions of the G.A.S. of the embodiment of FIG. 5. Dimensions may vary in other embodiments.

FIG. 8 is a perspective view of the G.A.S. according to another embodiment.

FIG. 9 is a more detailed view of the embodiment shown in FIG. 8.

FIG. 10 is a top view of an example of operation of the G.A.S of the embodiment shown in FIG. 8.

FIG. 11 is a side view of the G.A.S according to the embodiment shown in FIG. 8 illustrating some of the degrees of freedom of movement.

FIG. 12 is a top view of the G.A.S. of the embodiment shown in FIG. 8 illustrating other degrees of freedom of movement.

FIG. 13 is perspective view of the G.A.S. according to the embodiment shown in FIG. 8 illustrating how the arm may be folded and stowed.

FIG. 14 is another view of the G.A.S. according to the embodiment shown in FIG. 8 illustrating the multiple degrees of freedom of movement available with the embodiment.

The drawings are not necessarily to scale.

### DETAILED DESCRIPTION

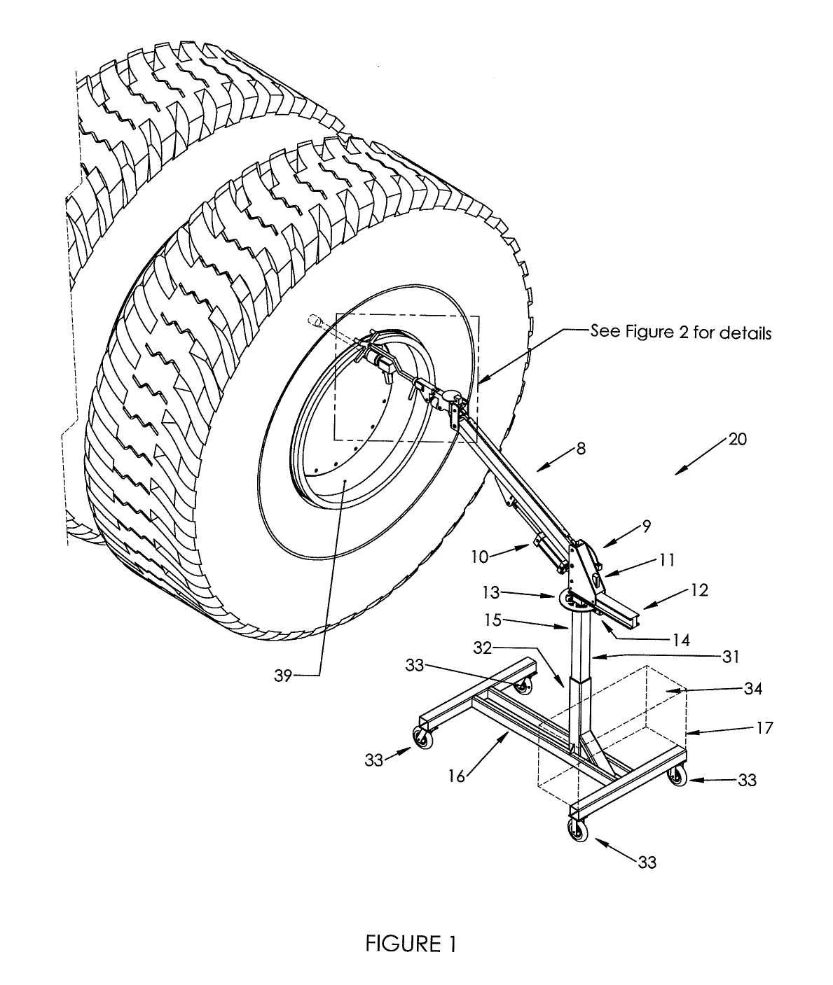

In one embodiment shown in FIGS. 1 to 4, there is provided a gravity assist system, referred to as G.A.S. (20). For illustration purposes, there is shown a tool (18), which may be a torque tool (such as a torque gun from Atlas Copco™, Hytorc™, or RAD™) for example, and which may have a cylindrical feature (19). In the embodiment shown, G.A.S. (20) includes a tool clamp (1), which may be solid. The tool (18) in the embodiment shown is connected to the G.A.S. (20) by securing the tool (18) into the tool clamp (1), which encompasses the cylindrical feature (19) of the tool (18) in the embodiment shown. The tool clamp (1) in the embodiment shown is releasable to allow for quick mounting and/or quick dismounting of the tool (18), which may facilitate efficiently interchanging tools in the tool clamp (1), and the tool clamp (1) in the embodiment shown can adjust to accommodate various cylindrical diameters of different tool sizes.

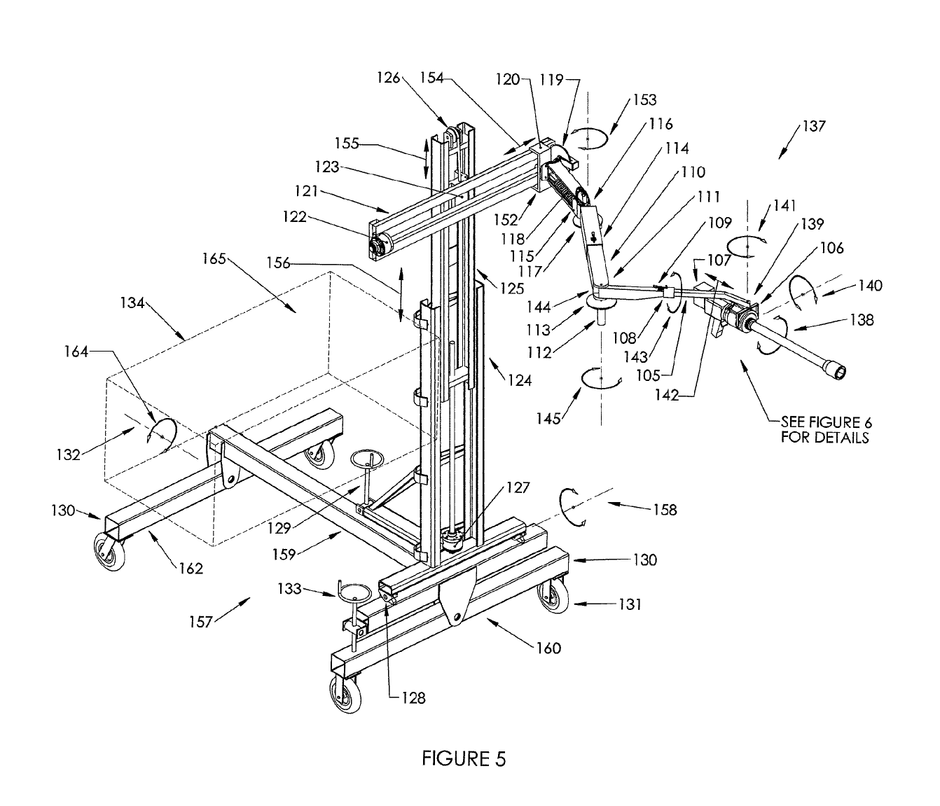

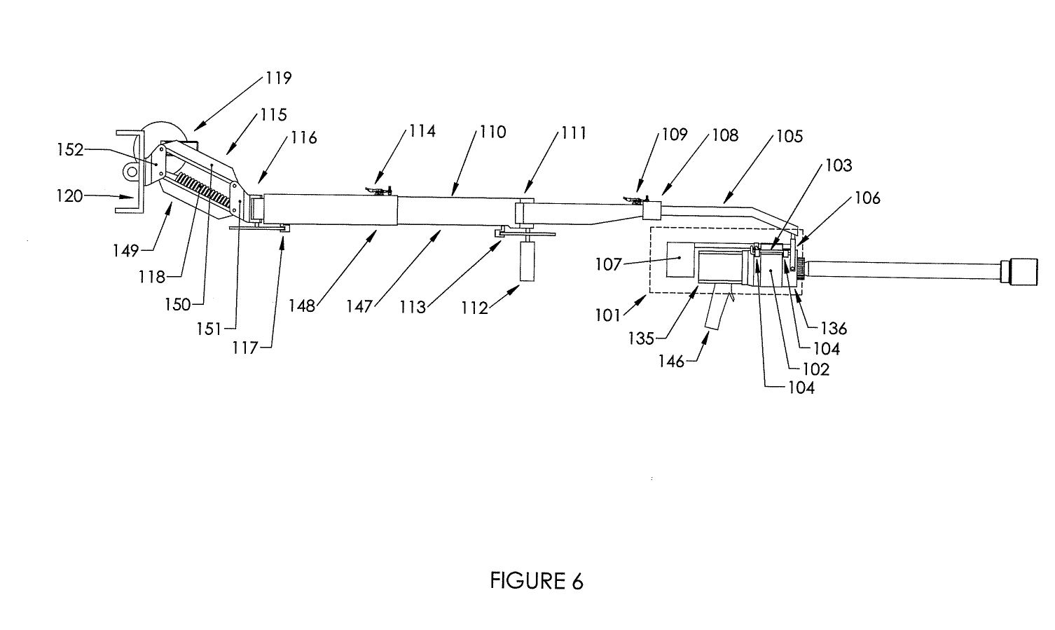

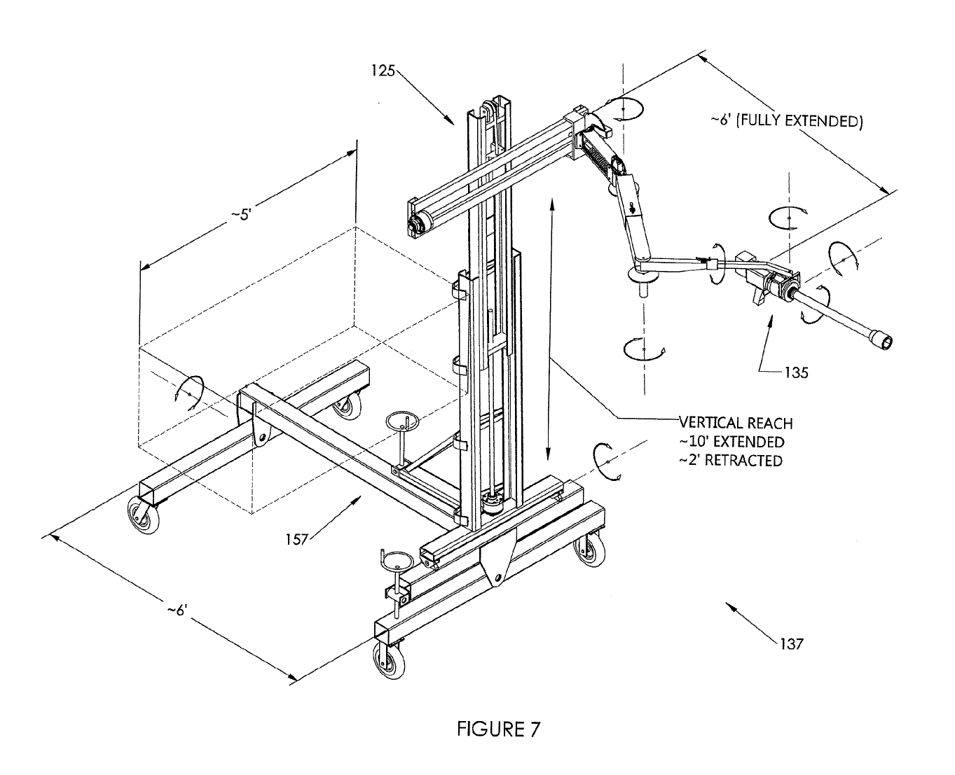

However, the tool clamp (1) in the embodiment shown is an example only, and alternative embodiments may include different tool clamps or other structures for connecting one or more different types of tools (which may or may not have cylindrical features) to the G.A.S. (20). For example, some embodiments may include a tool gimbal (101), a strap, chain, and/or belt (102), an idler roller (103), one or more fixed rollers (104), a yoke (106), and/or a counterweight (107) as described below with reference to FIGS. 5 to 7, for example.

Still referring to FIGS. 1 to 4, the G.A.S. (20) in the embodiment shown also includes a tool arm (2), which provides structural support to the tool clamp (1) through a solid connection to other components of the G.A.S. (20) as described below and as shown in FIGS. 1 to 3. The tool arm (2) in the embodiment shown is generally horizontal, but may have various other orientations or positions in other embodiments. The tool arm (2) in the embodiment shown also has a low profile, which may allow the tool (18) to be placed in close proximity to an obstruction near a fastener being tightened or loosened, such as a final drive of an ‘ultra-class’ mining haul truck such as a Komatsu™ 797, 930, or 980 truck, a Hitachi™ 5000 truck, or a Liebherr™ 282 truck, for example.

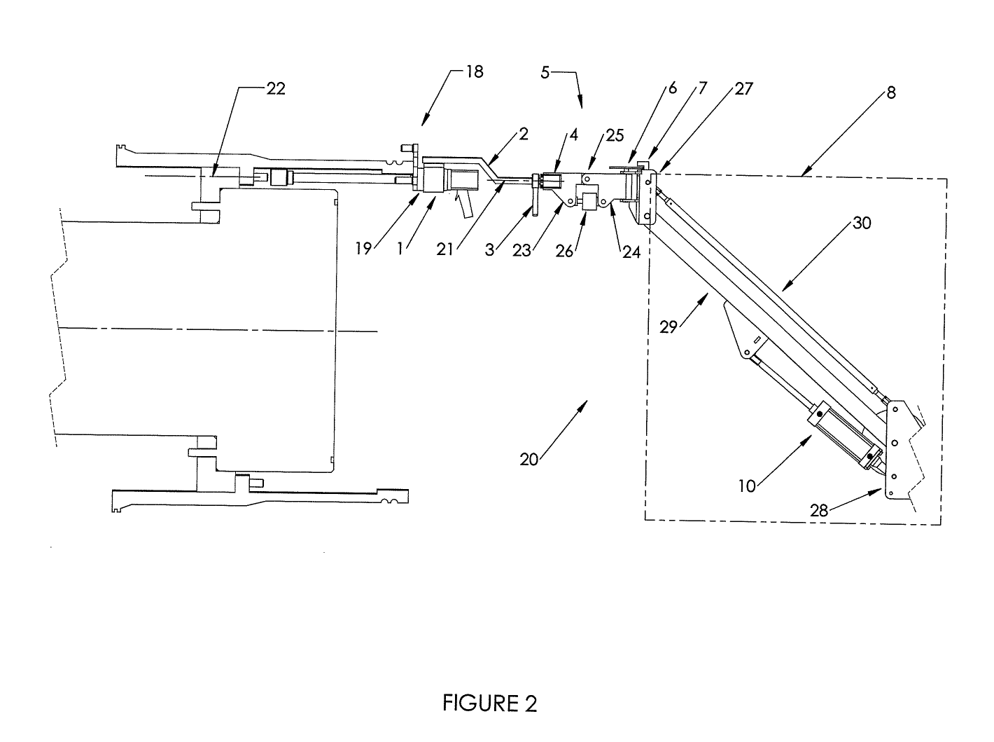

The G.A.S. (20) in the embodiment shown also includes a pitch knuckle (5) (in the embodiment shown the pitch knuckle can comprise references 23, 24, 25 and 26 in FIG. 2), which provides structural support to the tool arm (2) through a swivel bearing (4). The swivel bearing (4) has an axis (21), which may in some embodiments be aligned approximately with a centerline axis (22) of the tool clamp (1) and of the cylindrical feature (19) of the tool (18). The swivel bearing (4) may allow the tool arm (2) and the tool (18) to rotate approximately about the centerline axis (22). The rotating motion of the tool (18) approximately about the centerline axis (22) may be achieved with human force applied through a manipulating handle (3) and/or in other ways. In the embodiment shown, the manipulating handle (3) is connected to the tool arm (2) and may function as an axial positioner by rotating the tool arm (2) about the centerline axis (22). In the embodiment shown, the manipulating handle (3) can either be locked solid to the tool arm (2) to function as an axial positioner, or disengaged to allow the manipulating handle (3) to rotate about the axis of the tool arm (2) for re-engagement in a different angular position. However, in other embodiments, one or both of the swivel bearing (4) and the manipulating handle (3) may be omitted or may differ from the swivel bearing (4) and the manipulating handle (3) of the embodiment shown.

The pitch knuckle (5) in the embodiment shown includes a floating segment (23) and a fixed segment (24). The segments (23, 24) in the embodiment shown are connected with an axis pivot (25) (which may provide a horizontal axis pivot or in other embodiments a longitudinal axis pivot), allowing the two segments (23, 24) to rotate relative to each other (e.g. in the vertical plane or in another plane). In other embodiments, the pitch knuckle (5) may be omitted or may vary, for example to allow the two segments (23, 24) to rotate relative to each other about one or more axes that may differ from the axis of the pivot (25). In the embodiment shown, the floating segment (23) is connected to the tool arm (2) through the swivel bearing (4), and the fixed segment (24) is supported by other G.A.S. links as described below and as shown in FIGS. 1 to 3.

In the embodiment shown, the pitch knuckle (5) includes an adjustable mechanical assist device (26) mounted offset to the axis pivot (25) to counteract the moment applied by the loaded tool arm (2) on the floating segment (23), allowing the tool arm (2) to balance in a configurable position (such as horizontally or in another position), for example to accommodate various loads on the tool arm (2), which may result from different tools or from different tool extensions, for example. The tool arm (2) in the embodiment shown may thus be balanced and may then pitch freely relative to the fixed segment (24). In the embodiment shown, pitch motion is achieved with human input through the manipulating handle (3). However, in other embodiments, different mechanisms may balance the tool arm (2), and pitch motion may be achieved in other ways. In some embodiments, a protective covering may protect the pitch knuckle (5).

Some or all of the tool clamp (1), tool arm (2), manipulating handle (3), swivel bearing (4), pitch knuckle (5), swing pivot (6), and swing lock (7) may collectively be referred to as a ‘strong arm’ or as a ‘strong arm assembly’ of the G.A.S. (20).

The G.A.S. (20) in the embodiment shown also includes a fixture or lift arm (8), which provides structural support to the pitch knuckle (5) through swing pivot (6). In the embodiment shown, the swing pivot (6) has an axis (e.g. a vertical axis) that allows the pitch knuckle (5) to swing about the end of the lift arm (8). In the illustrative embodiment in FIG. 2, given the orientation and position shown, the axis of the swing pivot allows the pitch knuckle to swing generally horizontally about the end of the lift arm. More generally, the swing pivot can allow the pitch knuckle to swing or move in a direction generally perpendicular to the longitudinal axis of the swing pivot. To fix a desired swing angle of the pitch knuckle (5) relative to the lift arm (8), the swing pivot (6) may include a swing lock (7), which (either on its own or in combination with one or more other locks such as those described herein) may for example prevent the tool (18) from swinging freely if a user releases the tool (18). In other embodiments, the swing pivot (6) may have a different axis, or the swing pivot (6) may otherwise be varied or omitted. In still other embodiments, positions of the pitch knuckle (5) and of the swing pivot (6) may be varied, so that for example the swing pivot (6) may provide structural support to the tool arm (2) through the swivel bearing (4), and the lift arm (8) may provide structural support to the swing pivot (6) through the pitch knuckle (5).

The lift arm (8) in the embodiment shown includes a floating end (27) and a fixed end (28). The ends (27, 28) in the embodiment shown are connected to each other with two parallel links (29, 30) that allow for generally vertical constrained movement between the two ends (27, 28) of the lift arm (8). Vertical positioning of the floating end (27) relative to the fixed end (28) may be achieved with human force alone applied through the manipulating handle (3), from a mechanical assistance device (10), which may be adjustable depending for example on the weight of a load in the tool clamp (1), or from human force applied through the manipulating handle (3) in combination with the mechanical assistance device (10). To fix a desired vertical position of the floating end (27), the lift arm (8) may include an elevation lock (9). In some embodiments, the lift arm (8) may be sized and shaped to reach over a work platform. In alternative embodiments, the lift arm (8) may vary, and may for example include one, or more than two, links between the ends (27, 28). Also, in alternative embodiments, the lift arm (8) may allow for movement between the two ends (27, 28) of the lift arm (8) in non-vertical directions, or in some embodiments the lift arm (8) may be otherwise varied or omitted.

The G.A.S. (20) in the embodiment shown also includes a slider (12), which provides structural support to the lift arm (8) through a series of sliders or rollers, allowing the lift arm (8) to move generally horizontally and linearly on the slider (12) while restricting relative horizontal movement of the lift arm (8) relative to the slider (12) to a generally horizontal linear direction of the slider (12), and while preventing vertical and rotational movement of the fixed end (28) of the lift arm (8) relative to the slider (12). To fix a horizontal linear position of the lift arm (8) relative to the slider (12), the lift arm (8) may include a slide lock (11). However, other embodiments may include different sliders, such as sliders that are not necessarily linear or that are not necessarily horizontal. Further, in some embodiments, the horizontal slider (12) may be otherwise varied or omitted.

The G.A.S. (20) in the embodiment shown also includes a mast (15), which provides structural support to the slider (12) through a turret bearing (13), allowing the slider (12) and the lift arm (8) to rotate about an axis (e.g. a vertical axis) of the mast (15). In the embodiment shown, rotating motion of the slider (12) and the lift arm (8) about the vertical axis of the vertical mast (15) may be achieved with human force applied through the manipulating handle (3) and/or in other ways. To fix a desired swing angle of the slider (12) relative to the mast (15), the turret bearing (13) may include a swing lock (14).

In summary, in the embodiment shown, the manipulating handle (3) may be used (a) to rotate the tool (18) approximately about the centerline axis (22), (b) to adjust pitch of the pitch knuckle (5), (c) to position the floating end (27) of the lift arm (8) above the fix end (28) in a motion that is generally toward or away from the fixed end (28) of the lift arm (8) or vertically relative to the fixed end (28), (d) to rotate the slider (12) and the lift arm (8) about the vertical axis or longitudinal axis of the mast (15), and (e) to adjust a linear position of the lift arm (8) along the slider (12). In other words, in the embodiment shown, a single manipulating handle can be controlled to move the tool (18) along multiple axes including vertically and horizontally, in pitch, and approximately about the centerline axis (22). Accordingly, in embodiments such as the embodiment shown in FIGS. 1 to 3, a user may operate the tool (18) with one hand and move the G.A.S. fixture or lift arm (8) using the other hand on the manipulating handle (3), thereby allowing movement of the G.A.S. fixture or lift arm (8) without having to remove the hand from the tool (18). However, alternative embodiments may include one or more different manipulating handles.

The mast (15) in the embodiment shown includes an upper segment (31) and a lower segment (32), which are connected to each other with a series of sliders or rollers, allowing the segments (31, 32) to move linearly relative to each other while restricting relative horizontal or rotational movement. Linear motion may be achieved with a powered or motorized actuator. However, in alternative embodiments, masts may be powered or otherwise movable in other ways. Further, alternative embodiments may include one or more different masts or other structures that may permit movement in one or more directions that are not necessarily vertical, or that may not permit movement at all. In still other embodiments, positions of the slider (12) and of the mast (15) may be varied, so that for example the slider (12) may provide structural support to the mast (15), and the mast (15) may provide structural support to the lift arm (8). In some embodiments, the mast (15) may be replaced with some or all of the slider (120), the mast (121), the slider (123), the primary mast (124), and to the secondary mast (125) as described below with reference to FIGS. 5 to 7, for example. In still other embodiments, the mast (15) may be otherwise varied or omitted.

Still referring to FIGS. 1 to 4, the G.A.S. (20) in the embodiment shown also includes a base (16), which provides structural support to the mast (15), for example through a pinned or bolted connection. The base (16) may be equipped with adjustable feet or adjustable caster wheels (33) that may accommodate uneven ground. In the embodiment shown, the base (16) can be separated from the rest of the G.A.S. (20) at the bolted connection, allowing the G.A.S. to be mounted onto mobile equipment or various fixed platforms. However, alternative embodiments may include different bases, and in some embodiments the base (16) may be omitted.

In the embodiment shown, a utility box (17) is attached to the base (16) to the rear of the mast (15), providing storage for tooling and accessories, for example. A top surface (34) of the utility box (17) may be located at a comfortable working height and may be reinforced to allow for use as a workbench. In some embodiments, the utility box (17) may be varied or omitted.

In various embodiments, the G.A.S. (20) is configured to allow a tool to be maneuvered and positioned within a defined work envelope or work area at least once, although the G.A.S. (20) advantageously can also allow for maneuvering and repositioning many times as or where needed.

One possible method of operating the G.A.S. (20) according to one embodiment is described below.

1. An operator places the G.A.S. (20) in a desired position relative to a work envelope (35), for example by moving the G.A.S. (20) on the caster wheels (33).

2. The operator connects a power supply of the G.A.S. (20) to a source of power.

3. The operator loads the tool (18) into the tool clamp (1).

4. The operator adjusts the force of the mechanical assist device (26) at the pitch knuckle (5) to balance the tool arm (2) horizontally or at another angle.

5. The operator releases the elevation lock (9).

6. The operator adjusts the force of the mechanical assist device (10) on the lift arm (8) to balance the lift arm (8) horizontally or at another angle.

7. The operator adjusts the height of the mast (15) to align the floating end (27) of the lift arm (8) with the approximate vertical midpoint of the work envelope (35).

8. The operator releases some or all of the positional locks (7, 9, 11, 14) and performs work within the work envelope (35).

In at least some embodiments, the operator may be able to move and use the tool (18) with no further adjustments of the G.A.S. (20) during work progress.

Methods according to alternative embodiments may include some but not all of the steps, and such steps may be in the same as, or in a different order than, the order indicated above.

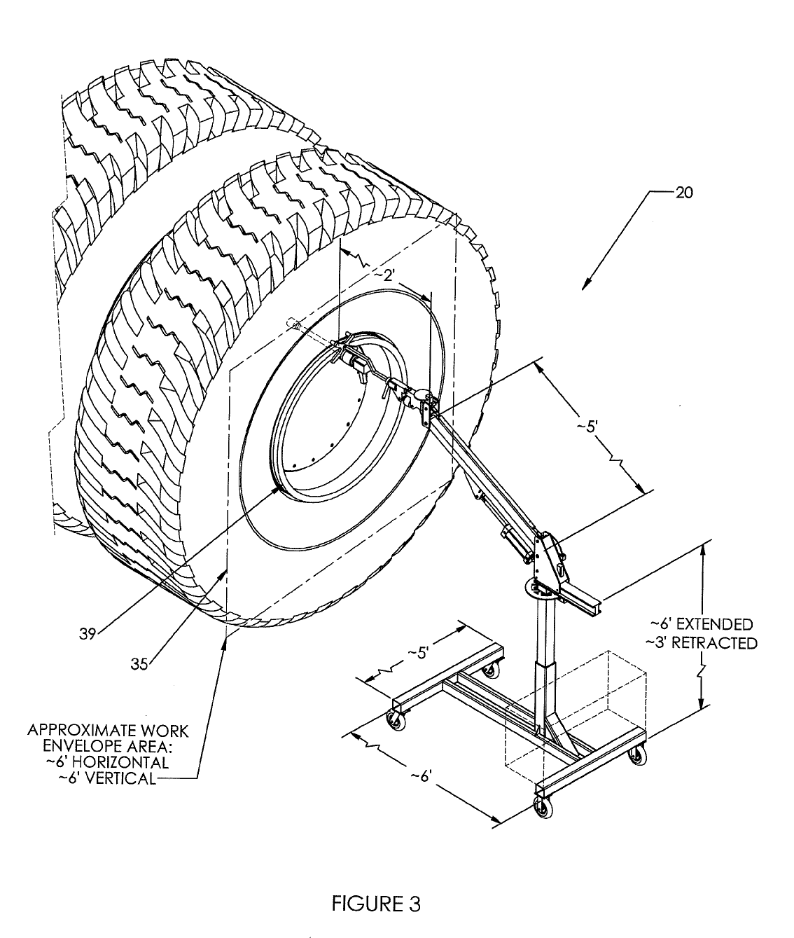

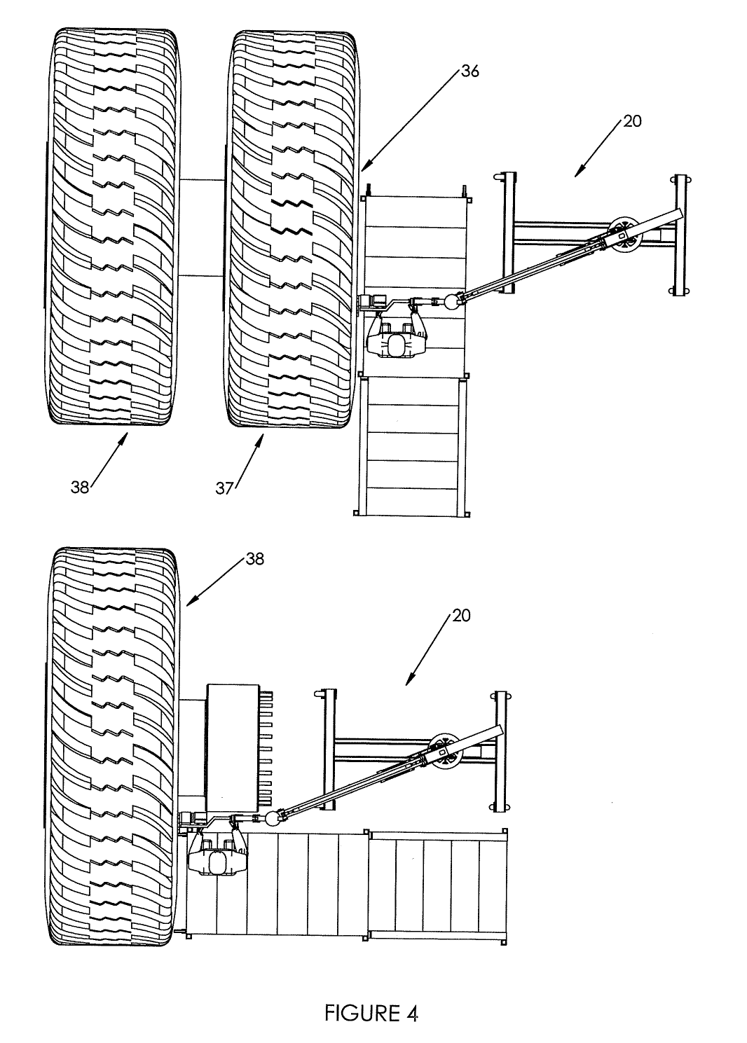

FIG. 4 illustrates the G.A.S. (20) positioning the tool (18) around a circumference of a tire rim (36) during removal of an outer wheel (37) in the top of FIG. 4, and during removal of an inner wheel (38) in the bottom of FIG. 4. FIGS. 1 and 3 illustrate another tire rim (39) and a final drive of an axle in one embodiment. The tire rims in the embodiments shown may be on an ‘ultra-class’ truck such as a Komatsu™ 797, 930, or 980 truck, a Hitachi™ 5000 truck, or a Liebherr™ 282 truck, for example. As shown in FIG. 4, the tool (18) may (for example) be used to remove nuts from wheels during removal of wheels from such a truck. In embodiments such as the embodiment shown, the ‘strong arm’ or ‘strong arm assembly’ may be moved around a work envelope (around a tire rim or a final drive of an ‘ultra-class’ truck, for example) without having to reconfigure the ‘strong arm’ or ‘strong arm assembly’.

In another embodiment shown in FIGS. 5 to 7, a tool (135), which may be a torque tool (such as a torque gun from Atlas Copco™, Hytorc™, or RAD™) for example, has a cylindrical feature (136), and a G.A.S. (137) includes a tool gimbal (101). The tool (135) in the embodiment shown is connected to the G.A.S. by securing the tool (135) into the tool gimbal (101) with a strap, chain, and/or belt (102), which may wrap around the cylindrical feature (136) of the tool (135), and which may be secured to the tool gimbal (101) by an idler roller (103). The idler roller (103) may be adjustable in some embodiments, and for example may be adjusted to tighten the strap, chain, and/or belt (102) and to hold the cylindrical feature (136) of the tool (135) against a set of fixed rollers (104) on the tool gimbal (101), which may allow the tool to roll freely in a rolling direction (138) along its cylindrical axis and within the tool gimbal (101). In at least some embodiments, such a strap and roller mechanism can accommodate various tools with various cylindrical diameters. However, the strap and roller mechanism in the embodiment shown is an example only, and alternative embodiments may include different tool clamps or other structures for connecting one or more different types of tools (which may or may not have cylindrical features) to the G.A.S. (137). For example, some embodiments may include one or more alternatives to the strap, chain, and/or belt (102), and in some embodiments, one or more of the tool gimbal (101), the idler roller (103), and the fixed rollers (104) may be varied or omitted.

The G.A.S. (137) in the embodiment shown also includes a tool arm (105), which provides structural support to the tool gimbal (101) and to the tool (135). In the embodiment shown, the tool gimbal (101) is connected to an endpoint (139) of the tool arm with a yoke (106), which allows the tool gimbal (101) to move in a pitch direction (140) and/or in a yaw direction (141) freely about the endpoint (139) of the tool arm (105). The tool arm (105) in the embodiment shown is horizontal, but tool arms in alternative embodiments may vary and may not necessarily be horizontal. Further, in some embodiments, the yoke (106) may be varied or omitted.

In a standard configuration of the embodiment shown, the yoke (106) is above the tool gimbal (101), with the yaw axis (defining the yaw direction 141) and the pitch axis (defining the pitch direction 140) intersecting an axis of the cylindrical feature (136) of the tool (135). To balance the tool (135) about the pitch axis, the tool gimbal (101) may be equipped with a counterweight (107) placed behind the tool (135), and the counterweight (107) may be brought farther from or closer to the yoke (106) by adjusting a position of the counterweight (107) linearly in an adjustment direction (142). The adjustability of the counterweight (107) may allow the tool gimbal (101) to balance various configurations of tools and tool attachments. However, in alternative embodiments, the counterweight (107) may be adjustable in other ways, and in some embodiments the counterweight (107) may be otherwise varied or omitted. Further, other embodiments may include alternatives to the counterweight (107).

In a non-standard configuration of the embodiment shown, the tool (135) may be brought above the tool gimbal (101) by rotating the tool gimbal (101) and the tool (135) 180 degrees (for example) in a rotation direction (143) about a centerline axis of the tool arm (105) at a pivot location (108). The tool arm (105) and the tool gimbal (101) may be locked in the standard or in the non-standard configuration with a locking mechanism (109) at the pivot location. However, in alternative embodiments, one or both of the pivot location (108) and the locking mechanism (109) may be varied or omitted.

The G.A.S. (137) in the embodiment shown also includes a horizontal lift arm (110), which may be extendable and/or retractable, and which provides structural support to the tool arm (105). The tool arm (105) in the embodiment shown is connected to an endpoint (144) of the lift arm (110), and a vertical-axis pivot (111) may allow the tool arm (105) to swing horizontally about the endpoint (144) of the lift arm (110) via human force in a horizontal pivot direction (145) or by other forces. A vertical handle (112), which may be directly below the vertical-axis pivot (111), may provide a means of manipulating an angle between the tool arm (105) and the lift arm (110), and may be used in combination with a handle (146) on the tool (135) in embodiments in which the tool (135) includes a handle (146). To fix a desired angle between the tool arm (105) and the lift arm (110), the vertical-axis pivot (111) may be equipped with a powered lock (113), which may be controlled by H.M.I. input.

In alternative embodiments, the lift arm (110) may not necessarily be horizontal, and the lift arm (110) may not necessarily be extendable or retractable. Further, in some embodiments, the axis of the pivot (111) and/or the handle (112) may not necessarily be vertical, and the pivot (111) may allow the tool arm (105) to move relative to the endpoint (144) of the lift arm (110) in one or more directions that may not necessarily be horizontal. In still other embodiments, the pivot (111) and/or the handle (112) may be otherwise varied or omitted.

In the embodiment shown, the lift arm (110) itself is extendable and retractable and includes two parallel structural segments (147, 148), which can move axially either farther apart or closer together by means of rollers and/or linear slider(s). Such motion may be achieved with human force applied through the vertical handle (112) and/or in other ways. To fix a desired extension distance, the lift arm (110) may be equipped with a powered lock (114), which may also be controlled by H.M.I. input.

The G.A.S. (137) in the embodiment shown also includes a twin-link assembly (115), which includes links (149, 150) having a floating end (151) and a fixed end (152), and which provides structural support to the lift arm (110). The links (149, 150) may be arranged in parallel to allow for vertical constrained movement of the floating end (151) relative to the fixed end (152) of the assembly (115). The floating end (151) of the assembly (115) may be connected to the lift arm (110) with a vertical-axis pivot (116), which may allow the lift arm (110) to swing horizontally about the floating end (151) in a horizontal pivot direction (153) via human force applied through the vertical handle (112) and/or in other ways. To fix a desired angle, the vertical-axis pivot may be equipped with a powered lock (117), which may be controlled by H.M.I. input. Vertical positioning of the lift arm (110) relative to the fixed end (152) of the assembly may be achieved via human force applied through the vertical handle (112) in combination with a mechanical assistance device (118) and/or in other ways. The mechanical assistance device (118) may be adjustable depending (for example) on the weight of the tool (135) and any tool attachments that may be used. To fix a desired vertical position of the tool arm (105) relative to the fixed end (152) of the assembly (115), the twin-link assembly (115) may be equipped with a powered lock (119), which may be controlled by H.M.I. input.

Alternative embodiments may include alternatives to the twin-link assembly (115), which may not necessarily include parallel links, and which may permit the floating end (151) to move relative to the fixed end (152) in other ways. Further, in other embodiments, the twin-link assembly (115) may be otherwise varied or omitted. In some embodiments, the pivot (116) may have an axis that may not necessarily be vertical, and the pivot (116) may allow the lift arm (110) to move relative to the about the floating end (151) in one or more directions that may not necessarily be horizontal. In still other embodiments, the pivot (116) may be otherwise varied or omitted.

The G.A.S. (137) in the embodiment shown also includes a horizontal slider (120), which provides structural support to the twin-link assembly (115), and may be connected directly to the fixed end (152) of the twin link assembly (115).

The G.A.S. (137) in the embodiment shown also includes a horizontal mast (121), which provides structural support to the horizontal slider (120). The horizontal slider (120) may include opposing rollers or bearings to secure the horizontal slider (120) to the mast (121), allowing the horizontal slider (120) to move linearly along at least a portion of a length of the horizontal mast (121) in a linear and horizontal sliding direction (154) while restricting relative vertical or rotational movement. The linear motion of the horizontal slider (120) relative to the horizontal mast (121) may be achieved with a powered actuator (122) and/or in other ways. However, in other embodiments, the slider (120) and the mast (121) may not necessarily be horizontal, and the slider (120) and the mast (121) may support the fixed end (152) of the twin link assembly (115) for movement in one or more directions that may not necessarily be horizontal. In still other embodiments, the slider (120) and the mast (121) may be otherwise varied or omitted.

The G.A.S. (137) in the embodiment shown also includes a vertical slider (123), which provides structural support to the horizontal slider (120) and the horizontal mast (121) and may be connected directly to the horizontal mast (121).

The G.A.S. (137) in the embodiment shown also includes a primary vertical mast (124) and a secondary vertical mast (125), which may work in conjunction to provide structural support to the vertical slider. The vertical slider (123) may be equipped with opposing rollers or bearings to secure the vertical slider (123) to the secondary vertical mast (125), allowing the slider to move linearly along at least a portion of a length of the secondary vertical mast (125) in a vertical direction (155) while restricting horizontal or rotational movement of the vertical slider (123) relative to the secondary vertical mast (125). The secondary vertical mast (125) may be equipped with opposing rollers or bearings to secure the secondary vertical mast (125) to the primary vertical mast (124), allowing the secondary vertical mast (125) to move linearly along at least a portion of a length of the primary vertical mast (124) in a vertical direction (156) while restricting horizontal or rotational movement of the secondary vertical mast (125) relative to the primary vertical mast (124). Linear motion of the vertical slider relative to the secondary mast may be achieved by a mechanical link (126), such as a chain, a cable, or another flexible link, for example, between the vertical slider (123) and the primary vertical mast (124) and routed over a pulley or roller that may be near a top end of the secondary vertical mast (125), for example—movement of the secondary vertical mast (125) relative to the primary vertical mast (124) may transfer a force to the mechanical link (126), which may affect proportionally the relative position of the vertical slider (123) to the secondary vertical mast (125). Linear motion of the secondary vertical mast (125) relative to the primary vertical mast (124) may be achieved with a powered actuator (127) and/or in other ways.

Other embodiments may include alternatives to the vertical slider (123), to the primary vertical mast (124), and/or to the secondary vertical mast (125). For example, some embodiments may include a single vertical mast, and the vertical slider (123) may or may not be movable relative to the single vertical mast. In at least some alternative embodiments, the mast or masts may have orientations that may not necessarily be vertical, and the mast or masts may allow movement of the slider (123) in one or more directions that may not necessarily be vertical. More generally, in other embodiments, some or all of the vertical slider (123), the primary vertical mast (124), and the secondary vertical mast (125) may be otherwise varied or omitted.

In the embodiment shown, the primary vertical mast (124) is connected to a base or frame (157) of the G.A.S. (137) through a horizontal-axis pivot (128) (also known as an axis pivot component or a pivot), and an axis (158) of the pivot (128) may be 90 degrees from a main frame rail (159) of the frame (157). An angle between the primary vertical mast (124) and the main frame rail (159) of the frame (157) may be set with an adjustable mechanical link (129). However, in other embodiments, the pivot (128) may include one or more axes that may not necessarily be horizontal and that may not necessarily be 90 degrees from the main frame rail (159) of the frame (157). In still other embodiments, one or more of the horizontal-axis pivot (128), the mechanical link (129), and the frame (157) may be otherwise varied or omitted.

Further, some embodiments may include different masts or other structures that may permit horizontal movement, vertical movement, or both horizontal and vertical movement of the assembly (115), and thus of the tool (135), relative to the frame (157). For example, in one embodiment, the frame (157) may support a horizontal slider that may slide horizontally relative to the frame (157), the horizontal slider may support a vertical mast, the vertical mast may support a vertical slider that may slide vertically relative to the vertical mast, and the vertical slider may support the assembly (115). Still other embodiments may include different combinations of masts and sliders. In some embodiments, at least two masts and at least two sliders may allow movement in different directions, which may not necessarily be vertical or horizontal, to permit horizontal movement, vertical movement, or both horizontal and vertical movement of the assembly (115), and thus of the tool (135), relative to the frame (157).

The frame (157) of the G.A.S. (137) in the embodiment shown is supported by beams (130) including a front beam (160) and a rear beam (162), and the beams (130) may rest on the ground, for example via attached feet or wheels (131) at each end of each of the beams (130). The beams (130) may articulate relative to the frame (157), which may in some embodiments facilitate use of the G.A.S. (137) on uneven ground. However, in alternative embodiments, one or both of the beams (130) and the wheels (131) may be varied or omitted.

The beams (130) may be connected to the frame (157) of the G.A.S. (137) via horizontal-axis pivots (132), and axes of the pivots (132) may be parallel and centered below the main frame rail (159), which may allow the frame (157), and thus the G.A.S. (137) as a whole, to tilt in side-to-side directions (164). An angle between the frame (157) and the beams (130) may be set with an adjustable mechanical link (133), which may be connected between the front beam (160) and the frame (157). The rear beam (162) may be free-floating, which may allow for full contact on uneven ground. In alternative embodiments, the pivots (132) and/or the mechanical link (133) may be varied or omitted.

A utility box (134) may be attached to the G.A.S. frame (157) to the rear of the vertical masts (124, 125). The utility box (134) may contain ancillary mechanical and/or electrical components of the G.A.S. (137), and may be equipped with doors and/or panels that may provide accessibility to the components. A top surface (165) of the utility box (134) may be located at a comfortable working height and may be reinforced to allow for use as a workbench. In some embodiments, the utility box (134) may be varied or omitted.

A user may operate the G.A.S. (137) according to a method that may be similar to the method described above for the G.A.S. (20) and that may be similar to the example shown in FIG. 4, for example by positioning the endpoint (144) of the lift arm (110) in a desired position, for example near a center of a work envelope, and moving the tool (135) within the work envelope.

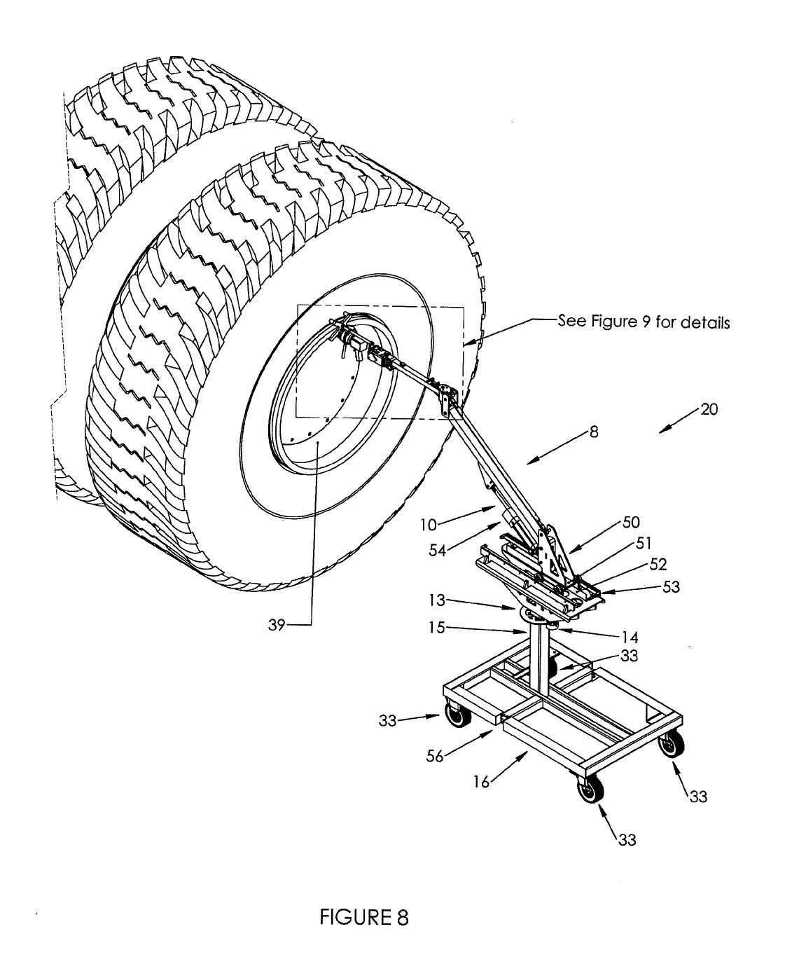

Further embodiments and variations of the G.A.S. are shown in FIGS. 8 to 14. In FIGS. 8 to 14, elements and components corresponding to elements and components shown in FIGS. 1 to 4 have been given the same reference numbers. Modifications or variations to the elements, components or design shown in FIGS. 8 to 14 are discussed below.

### 1. Relocation of the Manipulating Handle (3)

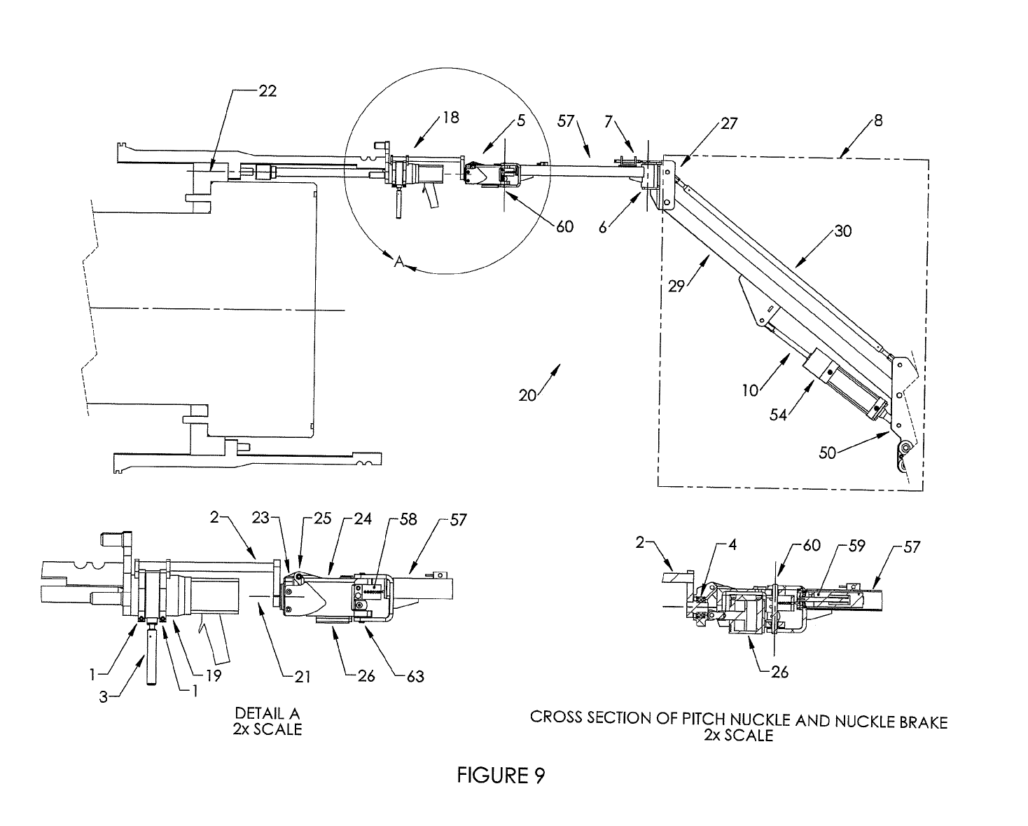

In some embodiments, such as in FIG. 9, the manipulating handle (3) may be positioned on the tool cylindrical feature (19). This can allow a human operator to manipulate the tool more comfortably when it is connected to the G.A.S. (20), keeping his or her hands closer together as both the tool and the handle are manipulated (e.g. concurrently or in series but closely in time). The manipulating handle (3) is configured to rotate about the axis (22) of the tool clamp as well, and can be locked to a specific angular position on the cylindrical feature (19) by twisting the grip of the handle.

### 2. Shortening of Tool Arm (2)

The tool arm may be shortened to bring the pitch knuckle (5) closer to the tool (18). This makes it easier for the operator to ‘yaw’ the tool by minimizing or reducing the swing radius about the swing pivot (6) relative to some of the other embodiments.

### 3. Extension Arm (57)

An extension arm (57) may be added in between the pitch knuckle (5) and the floating end (27) of the lift arm (8). The extension arm (57) gives the tool more reach from the lift arm, and can make up for the loss of reach by shortening the tool arm where that variation is adopted.

### 4. Addition of Knuckle Pivot and Brake

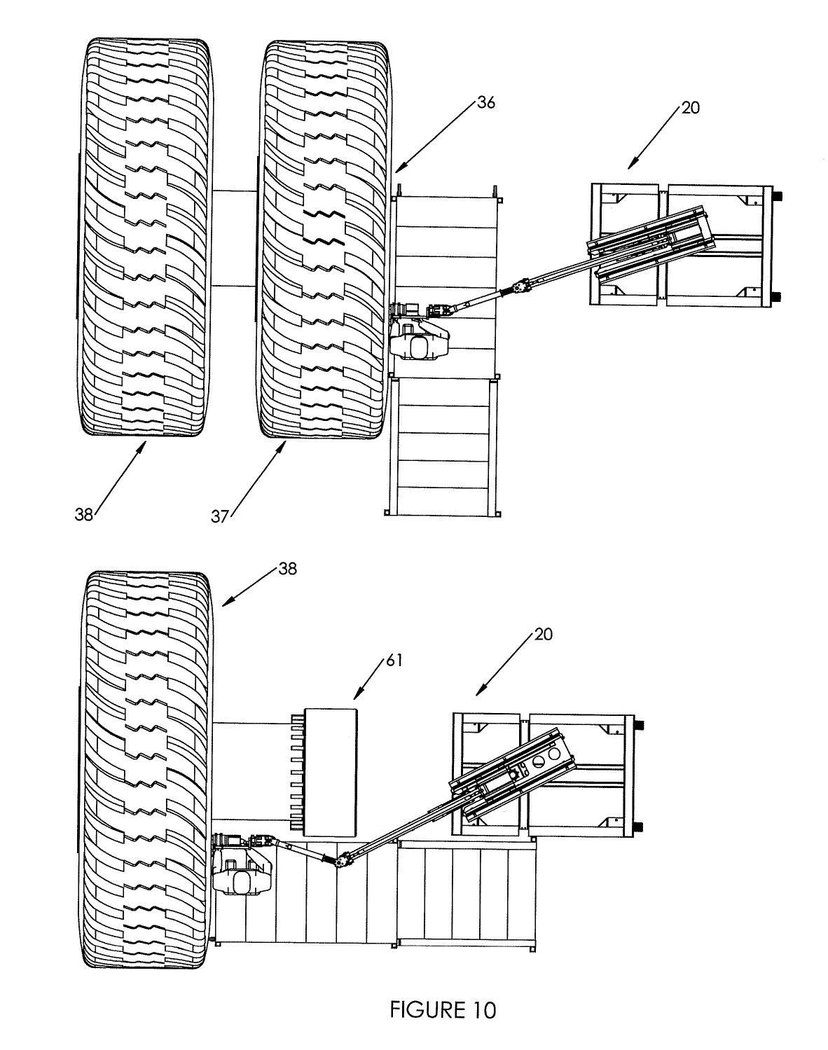

A pitch knuckle pivot (63), knuckle brake drum (58), and knuckle brake actuator (59) may be added between the extension arm (57) and the pitch knuckle fixed segment (24). This additional pivot and brake location provides for greater operational freedom, allowing for greater articulation of components. Such an embodiment provides for a modified G.A.S. (20) configured to enable the tool (18) to be navigated around obstacles, such as the wheel hub (61) of a mine truck. This is demonstrated in FIG. 10 (lower image).

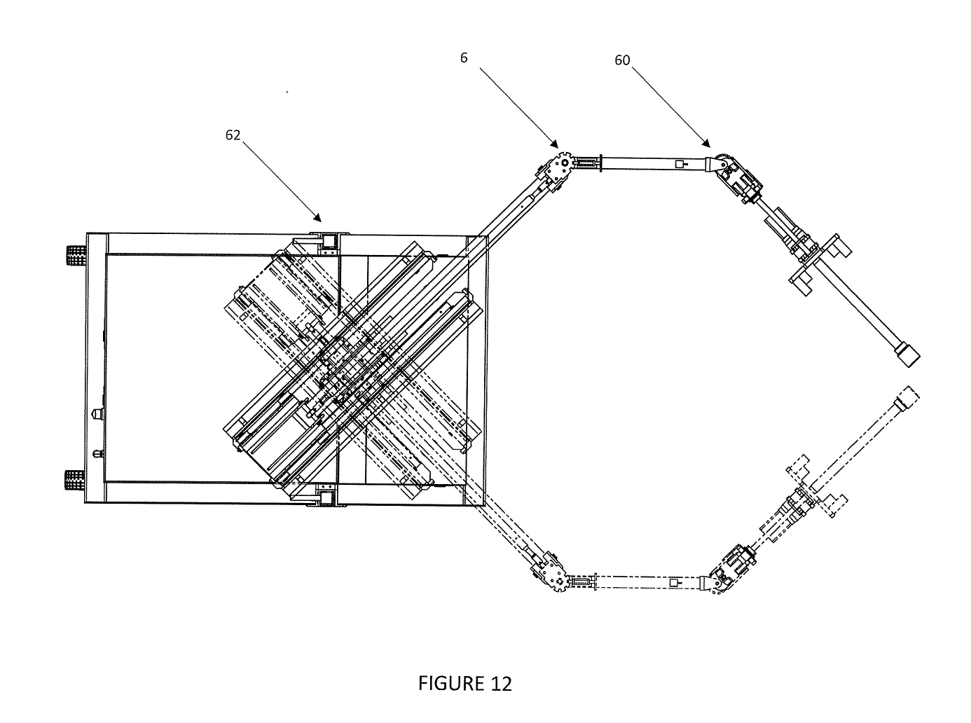

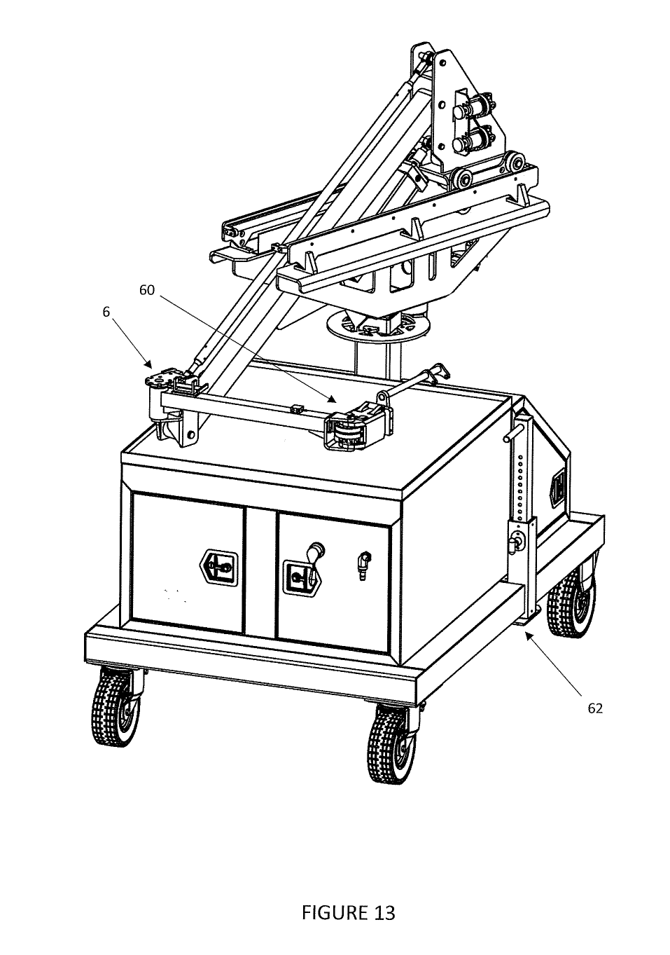

The horizontal articulation of the extension arm and pitch knuckle are also demonstrated in FIG. 12 which is a top-down view of a modified G.A.S. (20). Another advantage to the additional pivot location is the ability to fold the extension arm and pitch knuckle toward the lift arm for stowing the G.A.S., as shown in FIG. 13.

During operation of the embodiment shown in FIG. 9, the knuckle brake (58, 59) is not locked. The swing pivot (6) can remain locked during use, by engaging the swing lock (7). This can prevent the lift arm from swinging uncontrollably relative to the tool (18), as the operator is generally only handling the G.A.S. by grasping the manipulating handle (3) and tool handle.

### 5. Replacement of Slider (12)

The slider (12) shown in FIG. 1 may be replaced with a rail track (53) and trolley (50) system. In various embodiments, the combined rail track (53) and trolley (50) enables the lift arm (8) to be lowered in between the track rails.

### 6. Replacement of Slide Lock (11)

The slide lock (11) shown in FIG. 1 may be replaced with a slide brake caliper (51—not shown as it is under the trolley) and a slide brake rail (52).

### 7. Modification of Elevation Lock (9)

The elevation lock may be replaced with an elevation lock built into the mechanical assist device (10).

### 8. Addition of Outriggers

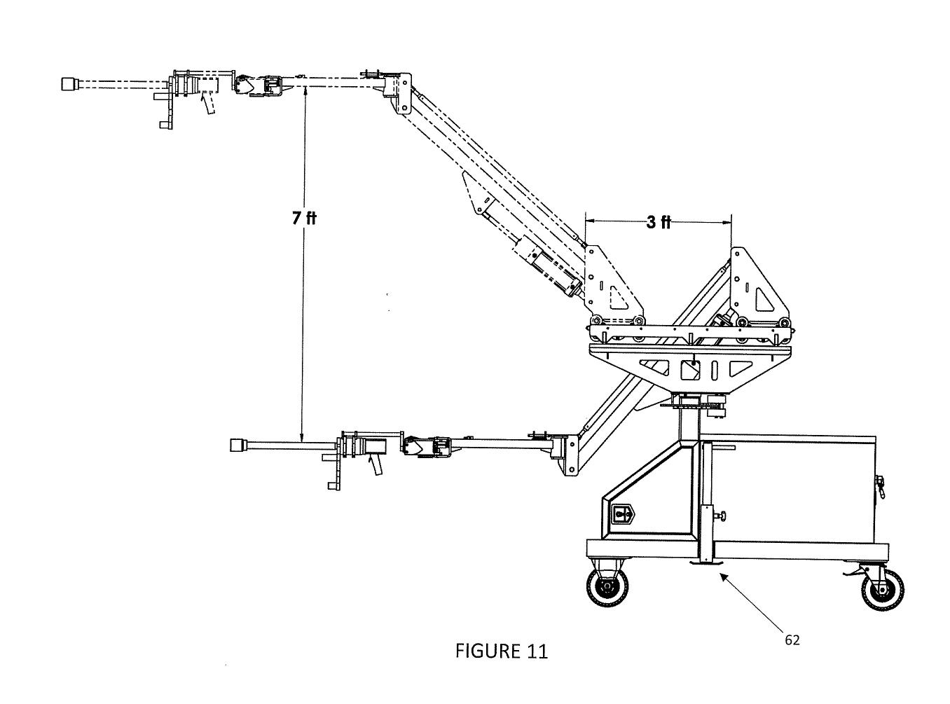

The base (16) may be fitted with outrigger housings (56) for the purpose of accommodating outriggers (62) shown in FIGS. 11 through 13. Outriggers prevent the G.A.S. from tipping over with heavy loads.

In general, embodiments such as those described herein may allow a tool to be positioned within a work envelope, while allowing movement of the tool within the work envelope without relocating the base. For example, embodiments such as those described herein may allow a tool to be movable around a circumference of a tire rim, and some embodiments may allow the tool to be movable in multiple degrees of freedom (e.g. three, four, five or six degrees of freedom, depending on the embodiment). In at least some embodiments, links may include protective coverings.

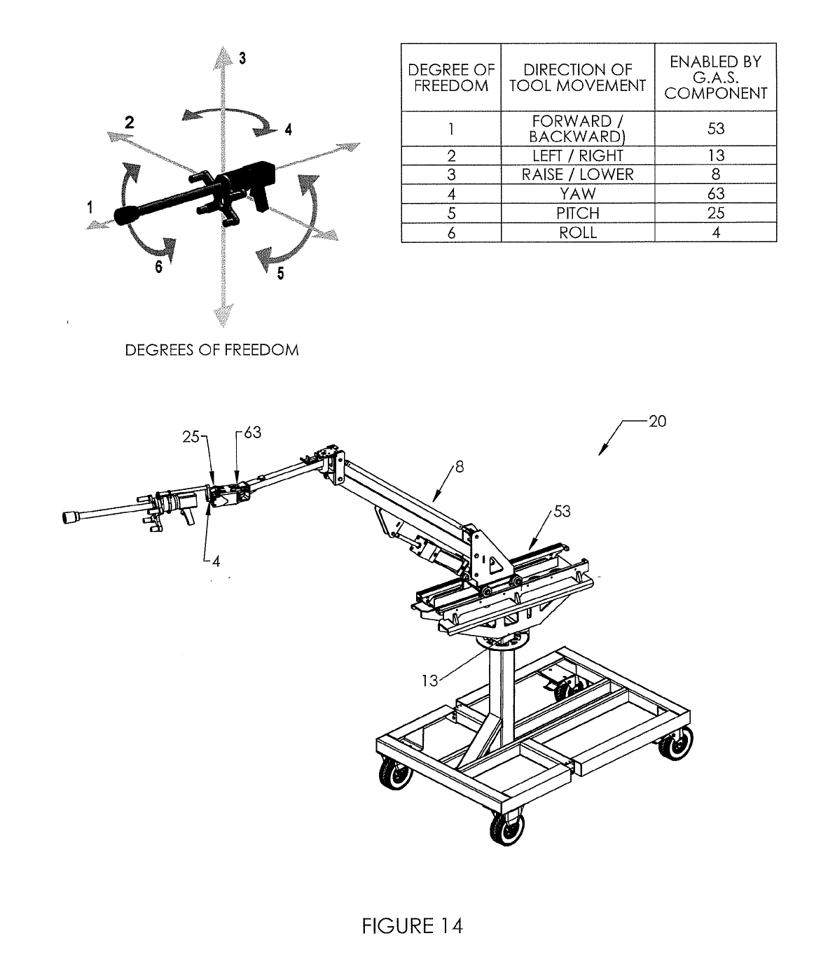

Referring to FIG. 14, there is shown an illustrative embodiment of G.A.S. (20) adapted with the modifications discussed above in respect of FIGS. 8 to 13, along with a table and conceptual presentation of a tool to illustrate six degrees of freedom of movement which may be achieved with various embodiments. In the embodiment shown,

(a) a first degree of freedom is provided for with rail track (53) which provides for forward and backward movement,

(b) a second degree of freedom is provided for with turret bearing (13) which provides for axial rotation of rail track (53) and the remaining distal components of the G.A.S. (and any tool attached) around mast (15) (effectively rotational movement around the mast),

(c) a third degree of freedom is provided for with lift arm (8) which is configured to enable the raising and lowering of the lift arm (8) (and thus the raising and lowering of the remaining distal components of the G.A.S. and any tool attached),

(d) a fourth degree of freedom is provided for with pitch knuckle pivot (63) (also referred to as 60 in FIGS. 9, 12 and 13), which allows for yaw movement,

(e) a fifth degree of freedom is provided for with axis pivot (25) which allows for pitch movement, and

(f) a sixth degree of freedom is provided for with swivel bearing (4) which allows for roll.

In accordance with various embodiments, there is provided an apparatus for assisting in maneuvering and positioning a tool within a work envelope, the apparatus comprising: a tool clamp configured to releasably connect to the tool; a tool arm operably connected to the tool clamp; a pitch knuckle operably connected to the tool arm, the pitch knuckle comprising an axis pivot, a floating segment and a fixed segment, wherein the axis pivot connects the floating segment and the fixed segment and allows the floating segment and the fixed segment to rotate relative to each other; a swing pivot; a lift arm connected to the pitch knuckle via the swing pivot, the swing pivot configured to allow the pitch knuckle to swing along a plane relative to the lift arm; a base including a mast; and a slider operably connected to the lift arm and the mast, wherein the slider is operably configured to move generally towards and away from a front portion of the base.

In some embodiments, the pitch knuckle includes an adjustable mechanical assist device mounted offset to the axis pivot to counteract force applied by the tool arm on the floating segment to allow the tool arm to balance and pitch freely relative to the fixed segment. In some embodiments, the floating segment is connected to the tool arm via a swivel bearing. In some embodiments, the apparatus further comprises a swivel bearing connected to the tool arm, the swivel bearing having an axis of rotation aligned with an axis of the tool clamp. In some embodiments, the swing pivot includes a swing lock to fix a swing angle of the pitch knuckle relative to the lift arm to prevent the tool from swinging freely. In some embodiments, the lift arm includes a floating end and a fixed end connected to the floating end to allowing generally vertical constrained movement between said ends. In some embodiments, the slider is operably configured to rotate around a longitudinal axis of the mast. In some embodiments, the mast includes an upper segment and a lower segment, connected by a series of sliders and rollers allowing segments to move linearly relative to each other while restricting relative horizontal or rotational movement; In other embodiments, the base is removable from the rest of the apparatus, allowing the apparatus to be mounted onto mobile equipment or other fixed platforms. In other embodiments, a utility box is attached to the base providing storage, wherein a top surface of the utility box is configured to allow for use as a workbench.

The embodiments described above may be varied in many different ways, for example by combining one or more structures from one of the embodiments described above into another one of the embodiments described above, by varying or omitting some structure of the embodiments described above, or by rearranging one or more structures of the embodiments described above, for example by varying the sequence or position of one or more such structures in alternative embodiments that function substantially as described above. For example, orientations that are described above as “vertical” or “horizontal” may not necessarily be vertical or horizontal in some embodiments, but rather may vary in ways that may function substantially as described above. As another example, where “human force” is described above, alternative embodiments may include other forces in addition or in the alternative to human force, and more generally the embodiments described above may be varied to include different or additional means for applying forces. In general, the drawings may not be to scale, and dimensions may vary in other embodiments.

More generally, although specific embodiments have been described and illustrated, such embodiments should be considered illustrative only and not as limiting the invention.

1. An apparatus for assisting in maneuvering and positioning a tool within a work envelope, the apparatus comprising:
a tool clamp configured to releasably connect to the tool;
a tool arm operably connected to the tool clamp;
a pitch knuckle operably connected to the tool arm, the pitch knuckle comprising an axis pivot, a floating segment and a fixed segment, wherein the axis pivot connects the floating segment and the fixed segment and allows the floating segment and the fixed segment to rotate relative to each other;
a swing pivot;
a lift arm connected to the pitch knuckle via the swing pivot, the swing pivot configured to allow the pitch knuckle to swing along a plane relative to the lift arm;
a base including a mast; and
a slider operably connected to the lift arm and the mast, wherein the slider is operably configured to move generally towards and away from a front portion of the base.

2. The apparatus according to claim 1 wherein said pitch knuckle includes an adjustable mechanical assist device mounted offset to the axis pivot to counteract force applied by the tool arm on the floating segment to allow the tool arm to balance and pitch freely relative to the fixed segment.

3. The apparatus according to claim 1 wherein the floating segment is connected to the tool arm via a swivel bearing.

4. The apparatus according to claim 1 further comprising a swivel bearing connected to the tool arm, the swivel bearing having an axis of rotation aligned with an axis of the tool clamp.

5. The apparatus according to claim 1 wherein the swing pivot includes a swing lock to fix a swing angle of the pitch knuckle relative to the lift arm to prevent the tool from swinging freely.

6. The apparatus according to claim 1 wherein the lift arm includes a floating end and a fixed end connected to the floating end to allowing generally vertical constrained movement between said ends.

7. The apparatus according to claim 1, wherein the slider is operably configured to rotate around a longitudinal axis of the mast.

8. The apparatus according to claim 1, wherein the mast includes an upper segment and a lower segment, connected by a series of sliders and rollers allowing segments to move linearly relative to each other while restricting relative horizontal or rotational movement;

9. The apparatus according to claim 1, wherein the base is removable from the rest of the apparatus, allowing the apparatus to be mounted onto mobile equipment or other fixed platforms.

10. The apparatus according to claim 1, wherein a utility box is attached to the base providing storage, wherein a top surface of the utility box is configured to allow for use as a workbench.
